(19) United States
(12) Patent Application Publication
(10) Pub. No.: US 2012/0012421 A1
(43) Pub. Date: Jan. 19, 2012

(54) Harness and Lift Sling

(75) Inventors: William Bevly Morgan, Santa Barbara, CA (US); Connie Lyn Morgan, Santa Maria, CA (US); Trent Matthew Schultz, Goleta, CA (US); Mike Von Alvensleben, Santa Maria, CA (US)

(73) Assignee: Kirby Morgan Dive Systems, Inc.

(21) Appl. No.: 13/184,110

(22) Filed: Jul. 15, 2011

Related U.S. Application Data
(60) Provisional application No. 61/365,292, filed on Jul. 16, 2010.

(51) Int. Cl. A62B 35/00

(52) U.S. Cl. 182/3

(57) ABSTRACT

A safety harness and quick connecting lifting sling used by people such as commercial divers that are required to wear some type of helmet or head gear (such as a diving helmet or full face mask) while being lifted wearing the safety harness. The harness is designed with multiple attachment points that are used to quickly connect the lifting sling for lifting the diver in or out of the water. The lifting sling has been specifically designed with one or more net structures that are used to stabilize the head area and support the weight of the head gear (diving helmet or mask) when the diver is lifted to help prevent neck fatigue and/or injuries to the diver, even if the person is unconscious.

### BACKGROUND OF THE INVENTION

This patent application claims the benefit of U.S. Provisional Patent Application No. 61/365,292, entitled “Harness and Lift Sling” filed Jul. 16, 2010 which application is incorporated in its entirety here by this reference.

### TECHNICAL FIELD

This invention relates to personal protective gear, more specifically to safety harnesses and lifting sling systems used with them by people like commercial divers who are required to wear head protection such as a commercial diving helmet or full face mask while being lifted in the harness.

### BACKGROUND ART

There many examples of safety harnesses in the world today. Harnesses for people working in high places to prevent falls, rock climbing sport harnesses, diving harnesses and parachute harnesses are all good examples of the variety of safety harnesses.

The safety harnesses that are used today by commercial divers are somewhat unique. In the commercial diving industry the harness is primarily used more as a backpack for the mounting of the self contained under water breathing apparatus (SCUBA) air cylinder (reserve air) to the divers back and are very rarely used as a safety harness to lift the diver, usually only for an emergency.

Since the commercial diving harnesses are used more as a backpack and are rarely used as a safety/lifting harness, they have been designed with a “jock strap” type of system that goes between the legs to help prevent the harness from being pulled off of or, the person from slipping out of, the harness during lifting. The “jock strap” type of systems are quick and easy to install and use but they do not support the lower portion of body correctly and are usually extremely uncomfortable for the person while being lifted.

Most commercial divers today also wear a diving helmet that typically weighs around 30 pounds out of the water or a full face diving mask that can weigh about 15 pounds out of the water. The weight of the helmet or mask on the divers head when entering or exiting the water can fatigue the diver's neck and be potential for injury to the diver's neck.

All of the current commercial diving harness on the market today use a single attachment point (usually located high on the back just behind the head) to attach the safety line or rope that is used to lift the diver out of the water. Because of this and the way that the current harnesses have been designed, when lifting, the diver ends up in a very awkward and uncomfortable position. With the added weight of a diving helmet or mask, this adds to the potential of causing injury to the diver.

If a diver is unconscious there is nothing to help support the weight of the helmet or mask during lifting, it greatly increasing the chances for causing neck injuries.

### BRIEF SUMMARY OF INVENTION

It is the intention of this invention to create a safety harness and lift sling system for the safety harness that properly supports the body of the person being lifted and to help support and stabilize the head area during lifting.

The inventive harness and lifting sling are preferably made from a strong, flexible, waterproof material such as a nylon webbing with stainless steel hardware (i.e., buckles, clasps, D-rings, etc.).

The embodiments of the invention can be manufactured in several different forms and/or configurations. For example, the harness can be configured to allow for the additional attachment of SCUBA diving air cylinders, buoyancy compensators, and/or extra accessory attachment points.

In one of the preferred embodiments, the harness has three points of attachment that are used for connecting the lifting sling. It is understood that the harness can have one or more points of attachment with corresponding points of attachment on the lifting sling; for example, the harness can have four (4) or five (5) points of attachment that securely and removeably connect to the lift sling support lines of the lifting sling.

In two preferred configurations, there are unique locations of attachment utilizing three lift sling support lines and three attachment points on the safety harness. In a first configuration, there is an attachment point high on the top of the back behind the head, and one on each side of the body (left & right) just above the hips facing forward. The left and right hip attachment points are part of one support strap that is an integral part of the harness that starts high on one side of the hip extends down the torso, around and under the thigh/buttocks and back up the other side as to create a swing type of seat.

In this configuration a smaller jock strap type of system may be used to keep the support strap that creates the left and right hip attachment points and swing type seat correctly positioned on the thigh/buttocks to support the lower part of the body and to prevent the harness from coming off.

A second preferred configuration for the three attachment points on the safety harness is, one attachment point high on the top of the back behind the head (same as the first), and one on the top of each leg strap (left & right). In this configuration the leg straps of the harness are adjustable to accommodate for all leg sizes and to help keep the leg straps low on the thigh preventing them from sliding up into the crotch area. This helps correctly position the person while being lifted.

The attachment points can be made from or formed out of the same material/webbing that the rest of the harness is made of or, they can be a metal buckle type of attachment point (i.e. D-ring made of stainless steel or other strong material such as plastic, and other types of metals) sewn into the structure of the harness.

With the harness designed with the three attachment points located as described this allows the lower portion of the body to be properly supported by the lift sling and the body to be lifted in more of a seated position similar to that of sitting in a swing or chair.

The intention of the location of the attachment points is that when the lift sling is attached to the harness and the person is lifted, the person's head is captured between the support lines of the lift sling supporting and stabilizing the head.

In the preferred embodiments a net structure is securely located head high between the two front support lines of the lifting sling. The net structure is used to cradle the head and prevent it from falling forward during lifting. If the person is required to wear a helmet, such as a commercial diver, the net structure helps support the weight of the helmet by allowing the knobs and/or protruding edges of the helmet to be caught in the net stabilizing and supporting the weight of the helmet during lifting.

The lifting sling and net structure are preferably made from a strong, flexible, waterproof material such as a nylon webbing similar to what the harness is made of and also has stainless steel hardware (i.e. hooks, links, D-rings, etc.).

The lifting sling can be equipped with either quick connecting metal hooks or hooks with latches that close, securely attaching the lifting sling to the attachment points on the harness.

The one or more net structures can be made in a variety of shapes and sizes and can be attached between any combination of front, sides, or rear lifting sling supports. The height of the one or more net structures and length of the lifting sling supports can be adjustable to accommodate for different size people.

In addition to the one or more net structures additional quick connecting straps and/or means of support may be added to the lifting sling to further help support and stabilize the head area of the person.

Different parts of the material/webbing of the harness and the support lines of the lifting sling can be color coordinated (i.e. blue front, red back) so that the support lines of the lifting sling and be easily and quickly identified, oriented, and connected to the correct location attachment point on the harness.

### BRIEF DESCRIPTION OF THE DRAWINGS

FIG. 1 depicts a prior art harness for lifting a diver using a single attachment point located high on the back just behind the head to attach the safety line or rope that is used to lift the diver out of the water;

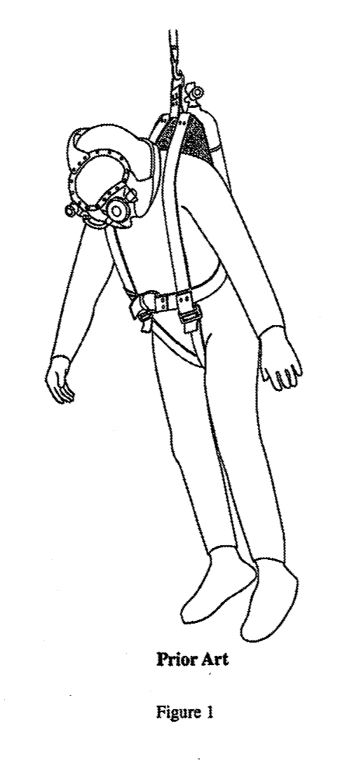

FIG. 2 is a perspective view of the one embodiment of the harness and lift sling in use as described herein; and

FIG. 3 is a perspective view of the one embodiment of the harness and lift sling in use as described herein.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized.

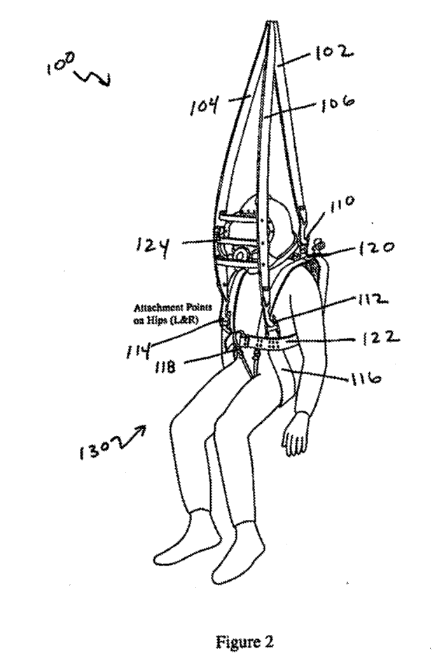

As shown in FIG. 2, a perspective view of one embodiment of the inventive harness 130 and lift sling 100 in use is shown. The embodiment shown 100 has three attachment points 110, 112, and 114 on the lift sling support lines 102, 104, and 106. One of the attachment points 110 at the end of one of the lift sling support lines 102 and at the top of the harness 120 is high on the top of the back behind the head. There are two other attachment points 112 and 114, one on each side of the body (left 112 and right 114) just above the hips facing forward. The left hip attachment point 112 is where the end of one of the lift sling support lines 106 meets the harness support strap positioned in front of the left hip 116. The right hip attachment point 114 is where the end of one of the lift sling support lines 104 meets the harness support strap positioned in front of the right hip 118. The harness strap positioned in front of the left hip 116 and the harness strap positioned in front of the right hip 118 are an integral part of the harness 130, starting high on one side of the hip, extending down the torso, around and under the thigh/buttocks and back up the other side so as to create a swing type of seat. The harness shown (collectively 116, 118, 120, 122, and 130) is a jock strap type of system used to keep the harness waist support strap 122 and the left 116 and right 118 hip harness straps and swing type seat created correctly positioned on the thigh/buttocks to support the lower part of the body and to prevent the harness from coming off. As shown, the lift sling 100 is equipped with a net structure 124 securely located at the height of the head between the two front lift sling support lines 104 and 106. The net structure 124 is used to cradle the head and prevent it from falling forward during lifting. In one embodiment the net structure 124 is designed to be capable of moving up or down the two front lift sling support lines 104 and 106 to accommodate divers of different heights. Alternatively, the two front lift sling support lines 104 and 106 can be adjustable in length to move the net structure up or down to accommodate divers of different heights. At the attachment points 110, 112, and 114 can be quick connecting hooks, hooks with latches, d-ring, or other secure attachment mechanisms that securely close and attach the lift sling support lines 102, 104, and 106 to the harness 130. The hooks, hooks with latches, d-ring, or other secure attachment mechanisms can be integral to the end of the lift sling support lines 102, 104, and 106 and/or the harness support straps 116, 118, and 120.

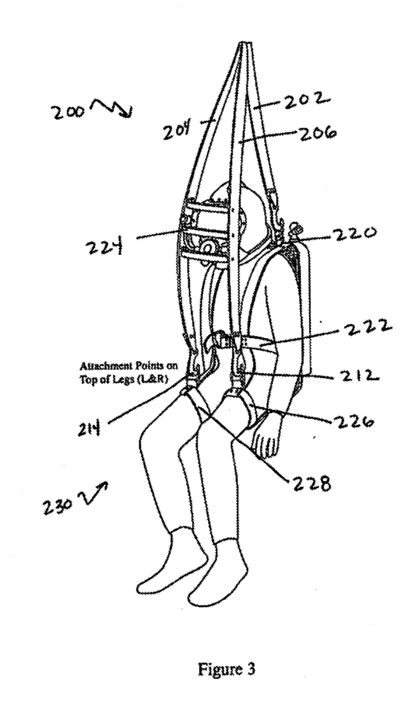

FIG. 3 depicts a perspective view of another embodiment of the inventive harness 230 and lift sling 200 in use is shown. The embodiment shown 200 has three attachment points 210, 212, and 214 on the lift sling support lines 202, 204, and 206. One of the attachment points 210 at the end of one of the lift sling support lines 202 and at the top of the harness 220 is high on the top of the back behind the head. There are two other attachment points 212 and 214, one on each side of the body (left 212 and right 214) on the top of each thigh. The left thigh attachment point 212 is where the end of one of the lift sling support lines 206 meets the harness support strap positioned around the left leg at the thigh level 216. The right thigh attachment point 214 is where the end of one of the lift sling support lines 204 meets the harness support strap positioned around the right leg at the thigh level 218. The harness leg straps at the thigh level 216 and 218 can be adjustable straps to accommodate divers of all shapes and sizes and be capable of being applied to a diver without having to lift it up over the feet and slide up the leg. Instead, a releasably adjustable latch can be integrated with the harness leg straps to enable quick application, removal, and fitting. The harness shown (collectively 216, 218, 220, 222 and 230) supports the lower part of the body to allow the diver to be lifted in a seated position similar to that of sitting in a swing or chair, and the unique configuration of the straps prevents the harness from coming off. As shown, the lift sling 200 is equipped with a net structure 224 securely located at the height of the head between the two front lift sling support lines 204 and 206. The net structure 224 is used to cradle the head and prevent it from falling forward during lifting. In one embodiment the net structure 224 is designed to be capable of moving up or down the two front lift sling support lines 204 and 206 to accommodate divers of different heights. Alternatively, the two front lift sling support lines 204 and 206 can be adjustable in length to move the net structure up or down to accommodate divers of different heights. At the attachment points 210, 212, and 214 can be quick connecting hooks, hooks with latches, d-ring or other secure attachment mechanisms that securely close and attach the lift sling support lines 202, 204, and 206 to the harness 230. The hooks, hooks with latches, d-ring, or other secure attachment mechanisms can be integral to the end of the lift sling support lines 202, 204, and 206 and/or the harness support straps 216, 218, and 220.

The foregoing descriptions of the preferred embodiments of the invention have been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A safety harness and lift sling system for a human body comprising
a. a safety harness constructed to fit the human body behind the head and around the waist, the safety harness having a harness support strap that circumvents the torso around the waist and further having a lower right harness strap attached to the harness support strap and positioned in front of the right hip and extending around the right thigh and right buttocks and a lower left harness strap attached to the harness support strap and positioned in front of the left hip and extending around the left thigh and left buttocks, an upper right harness strap attached to the harness support strap and extending up to the right shoulder, and an upper left harness strap attached to the harness support strap and extending up to the left shoulder, wherein the safety harness creates a swing seat for securing and supporting the human body, and wherein the safety harness is capable of being attached to a self contained under water breathing apparatus air cylinder;
b. the safety harness attached to a lift sling at two or more points of attachment, a first attachment point behind the head, a second attachment point on the left side of the body above the left hip, and a third attachment point on the right side of the body above the right hip;
c. the lift sling having two or more support lines, the first ends of each of the support lines closest to the body connected to the safety harness at an attachment point, and the second ends of each of the support lines terminating in close proximity to each other to assist in lifting the human body;
d. the attachment points being secure attachment mechanisms to securely close and attach the safety harness to the lift sling support lines selected from the group consisting of quick connecting hooks, hooks with latches, D-shaped rings, and buckles; and
e. wherein the lift sling assists in lifting the human body when it is attached to the safety harness and the orientation of the lift sling in connection with the safety harness provides a stable, supported structure to lift the human body.

2. The safety harness and lift sling system of claim 1 further comprising a net structure attached to the lift sling support lines at the level of the head, wherein the net structure cradles the head and prevents it from falling forward during lifting.

3. The safety harness and lift sling system of claim 2 wherein the net structure is comprised of three straps in parallel orientation to each other and perpendicularly attached at each end to two corresponding lift sling support lines.

4. The safety harness and lift sling system of claim 2 wherein the position of the net structure on the support lines is adjustable to accommodate human bodies of differing heights.

5. The safety harness and lift sling system of claim 1 wherein each of the secure attachment mechanisms is integral to a corresponding end of each of the lift sling support lines.

6. The safety harness and lift sling system of claim 1 wherein each of the secure attachment mechanisms is integral to the safety harness at each attachment point.

7. The safety harness and lift sling system of claim 1, wherein secure attachment mechanisms are D-shaped rings.

8. The safety harness and lift sling system of claim 7, wherein the D-shaped rings are made of a strong material consisting of a group selected from the materials such as stainless steel, plastic, or composite metals.

9. The safety harness and lift sling system of claim 1, wherein the lift sling support lines are adjustable in length.

10. The safety harness and lift sling system of claim 1, wherein all of the straps of the safety harness are adjustable in length to accommodate divers of differing sizes.

11. A safety harness and lift sling system for a human body comprising
a. a safety harness constructed to fit the human body behind the head and around the waist, the safety harness having a harness support strap that circumvents the torso around the waist and further having a right harness strap attached to the harness support strap and positioned in front of the torso extending from the right shoulder down to the right thigh and circumventing the right thigh, and a left harness strap attached to the harness support strap and positioned in front of the torso extending from the left shoulder down to the left thigh and circumventing the left thigh, wherein the safety harness creates a swing seat for securing and supporting the human body in a seated position, and wherein the safety harness is capable of being attached to a self contained under water breathing apparatus air cylinder;
b. the safety harness attached to a lift sling at two or more points of attachment, a first attachment point behind the head, a second attachment point on the left side of the body on top of the left thigh, and a third attachment point on the right side of the body on top of the right thigh;
c. the lift sling having two or more support lines, the first ends of each of the support lines closest to the body connected to the safety harness at an attachment point, and the second ends of each of the support lines terminating in close proximity to each other to assist in lifting the human body;
d. the attachment points being secure attachment mechanisms to securely close and attach the safety harness to the lift sling support lines selected from the group consisting of quick connecting hooks, hooks with latches, D-rings, and buckles; and
e. wherein the lift sling assists in lifting the human body when it is attached to the safety harness and the orientation of the lift sling in connection with the safety harness provides a stable, supported structure to lift the human body.

12. The safety harness and lift sling system of claim 11, further comprising a net structure attached, to the support lines at the level of the head, wherein the net structure cradles the head and prevents it from falling forward during lifting.

13. The safety harness and lift sling system of claim 12, wherein the net structure is comprised of three straps in parallel orientation to each other and perpendicularly attached at each end to two corresponding lift sling support lines.

14. The safety harness and lift sling system of claim 12, wherein the position of the net structure on the support lines is adjustable to accommodate human bodies of differing heights.

15. The safety harness and lift sling system of claim 11, wherein each of the secure attachment mechanisms is integral to a corresponding end of each of the lift sling support lines.

16. The safety harness and lift sling system of claim 11, wherein each of the secure attachment mechanisms is integral to the safety harness at each attachment point.

17. The safety harness and lift sling system of claim 11, wherein secure attachment mechanisms are D-shaped rings.

18. The safety harness and lift sling system of claim 17, wherein the D-shaped rings are made of a strong material consisting of a group selected from the materials such as stainless steel, plastic, or composite metals.

19. The safety harness and lift sling system of claim 11, wherein the lift sling support lines and the safety harness straps are adjustable in length.

20. A safety harness and lift sling system for a human body comprising
a. a safety harness constructed to fit the human body behind the head and around the torso and legs, wherein the safety harness creates a secure cradle for supporting the human body in a seated position while lifting, and the safety harness capable of being attached to a self contained under water breathing apparatus air cylinder,
b. the safety harness attached to a lift sling at two or more points of attachment,
c. the lift sling having two or more support lines,
d. wherein the lift sling assists in lifting the human body when it is attached to the safety harness and the orientation of the lift sling in connection with the safety harness provides a stable, supported structure to lift the human body.
